(19) United States
(12) Patent Application Publication
(10) Pub. No.: US 2026/0112324 A1
(43) Pub. Date: Apr. 23, 2026

(54) DISPLAY DEVICE AND OPERATION METHOD THEREOF

(71) Applicant: SAMSUNG ELECTRONICS CO., LTD., Suwon-si (KR)

(72) Inventors: Hoyeon KIM, Suwon-si (KR); Hwajin HAN, Suwon-si (KR)

(73) Assignee: SAMSUNG ELECTRONICS CO., LTD., Suwon-si (KR)

(21) Appl. No.: 19/307,765

(22) Filed: Aug. 22, 2025

Related U.S. Application Data
(63) Continuation of application No. PCT/KR2025/011123, filed on Jul. 25, 2025.

(30) Foreign Application Priority Data
Oct. 18, 2024 (KR) 10-2024-0143153

(51) Int. Cl. G09G 3/34

(52) U.S. Cl. CPC G09G 3/344; G09G 2320/0666; G09G 2340/0435

(57) ABSTRACT

A display device includes a display panel; at least one processor; and memory storing instructions, wherein the instructions, when executed by the at least one processor individually or collectively, may cause the display device to display first content on the display panel, based on receiving second content, display the second content on the display panel by refreshing a partial region of the display panel corresponding to the first content, and based on the partial region being refreshed, refresh a remaining region of the display panel corresponding to the second content, excluding the partial region.

### CROSS-REFERENCE TO RELATED APPLICATIONS

This application is a bypass continuation of International Application No. PCT/KR2025/011123, filed on Jul. 25, 2025, in the Korean Intellectual Property Receiving Office, which is based on and claims priority to Korean Patent Application No. 10-2024-0143153, filed on Oct. 18, 2024, in the Korean Intellectual Property Office, the disclosures of which are incorporated herein by reference in their entireties.

### BACKGROUND

### 1. Field

The present disclosure relates to a display device and an operation method thereof, and more particularly, to a display device including an electrophoretic display, and an operation method thereof.

### 2. Description of Related Art

As electronic technology advances, technological development for various types of electronic devices has been more actively pursued. In particular, technological development for various types of display devices for providing content to a user on a display has been in progress.

### SUMMARY

According to an aspect of the disclosure, a display device includes a display panel; at least one processor; and memory storing instructions, wherein the instructions, when executed by the at least one processor individually or collectively, cause the display device to display first content on the display panel, based on receiving second content, display the second content on the display panel by refreshing a partial region of the display panel corresponding to the first content, and based on the partial region being refreshed, refresh a remaining region of the display panel corresponding to the second content, excluding the partial region.

The the instructions, when executed by the at least one processor individually or collectively, may cause the display device to, based on receiving coordinate information and the second content, identify the partial region based on the coordinate information, and display the second content on the display panel by refreshing the partial region.

The instructions, when executed by the at least one processor individually or collectively, may cause the display device to sequentially refresh a plurality of pixels corresponding to the remaining region that are adjacent to the partial region, based on the coordinate information.

The instructions, when executed by the at least one processor individually or collectively, may cause the display device to refresh the plurality of pixels by sequentially refreshing the plurality of pixels in upper, lower, left, and right directions, at a predetermined time interval, starting with pixels closest to the partial region, and ending with pixels farthest from the partial region that are disposed along edges of the display panel.

The display panel may include a plurality of modules, and the instructions, when executed by the at least one processor individually or collectively, may cause the display device to identify at least one module that may include the partial region from among the plurality of modules, display the second content on the at least one module by refreshing a first plurality of pixels of the at least one module, and based on the first plurality of pixels being refreshed, refresh a second plurality of pixels of one or more remaining modules, from among the plurality of modules, excluding the at least one module.

The display panel may be an electrophoretic display.

The instructions, when executed by the at least one processor individually or collectively, may cause the display device to refresh the partial region by adjusting positions of a plurality of color particles corresponding to the partial region, and based on the partial region being refreshed, refresh the remaining region by adjusting positions of a plurality of particles of the remaining region.

The instructions, when executed by the at least one processor individually or collectively, may cause the display device to identify a first color corresponding to the first content being displayed in the partial region from among a plurality of color particles of the display panel; identify a second color corresponding to the second content to be displayed in the partial region, from among the plurality of color particles; arrange the plurality of color particles of the display panel, from the first color to the second color, based on a color circle including the first color and the second color; and sequentially adjust the plurality of color particles based on the arrangement of the plurality of color particles.

The instructions, when executed by the at least one processor individually or collectively, may cause the display device to, the first color and the second color matching, sequentially adjust the plurality of color particles based on a predetermined arrangement.

The instructions, when executed by the at least one processor, individually or collectively, may cause the display device to refresh the partial region by adjusting a plurality of color particles corresponding to a plurality of pixels included in the partial region based on the arrangement; and based on the partial region being refreshed, refresh the remaining region by adjusting a plurality of color particles of corresponding to a plurality of pixels included in the remaining region based on the arrangement.

According to an aspect of the disclosure, an operation method of a display device including a display panel includes displaying first content on the display panel; based on receiving second content, displaying the second content on the display panel by refreshing a partial region of the display panel corresponding to the first content; and based on the partial region being refreshed, refreshing a remaining region of the display panel corresponding to the second content, excluding the partial region.

The displaying the second content may include, based on receiving coordinate information and the second content, identifying the partial region based on the coordinate information; and displaying the second content on the display panel by refreshing the partial region.

The operation method may further include sequentially refreshing a plurality of pixels corresponding to the remaining region that are adjacent to the partial region, based on the coordinate information.

The sequentially refreshing the plurality of pixels may include sequentially refreshing the plurality of pixels in upper, lower, left, and right directions, at a predetermined time interval, starting with pixels closest to the partial region, and ending with pixels farthest from the partial region that are disposed along edges of the display panel.

The display panel may include a plurality of modules, and the displaying the second content may include identifying at least one module that includes the partial region from among the plurality of modules; and displaying the second content on the at least one module by refreshing a first plurality of pixels of the at least one module The refreshing the remaining region may include, based on the first plurality of pixels being refreshed, refreshing a second plurality of pixels included in one or more remaining modules, from among the plurality of modules, excluding the at least one module.

The display panel may be an electrophoretic display.

The displaying the second content may include refreshing the partial region by adjusting positions of a plurality of color particles corresponding to the partial region, and the refreshing the remaining region may include, based on the partial region being refreshed, refreshing the remaining region by adjusting positions of a plurality of particles of the remaining region.

The displaying the second content may include identifying a first color corresponding to the first content being displayed in the partial region from among a plurality of color particles of the display panel; identifying a second color corresponding to the second content to be displayed in the partial region, from among the plurality of color particles; arranging the plurality of color particles of the display panel, from the first color to the second color, based on a color circle including the first color and the second color; and sequentially adjusting the plurality of color particles based on the arrangement of the plurality of color particles.

The sequentially adjusting the plurality of color particles may include, based on the first color and the second color matching, sequentially adjusting the plurality of color particles based on a predetermined arrangement.

According to an aspect of the disclosure, a non-transitory computer-readable recording medium having at least one instruction recorded thereon, that, when executed by at least one processor, individually or collectively, cause the at least one processor to display first content on a display panel; based on receiving second content, display the second content on the display panel by refreshing a partial region of the display panel corresponding to the first content; and based on the partial region being refreshed, refresh a remaining region of the display panel corresponding to the second content, excluding the partial region.

### BRIEF DESCRIPTION OF DRAWINGS

The above and other aspects, features, and advantages of certain embodiments of the present disclosure are more apparent from the following description taken in conjunction with the accompanying drawings, in which:

FIG. 1 is a diagram for describing a display device according to an embodiment of the present disclosure;

FIG. 2 is a block diagram of an exemplary display device capable of performing operations described according to an embodiment of the present disclosure;

FIG. 3 is a diagram for describing the display device for displaying second content in which a partial region in first content is changed according to an embodiment of the present disclosure;

FIG. 4 is a diagram for describing the display device for sequentially refreshing pixels adjacent to the partial region according to an embodiment of the present disclosure;

FIG. 5 is a diagram for describing the display device for displaying the second content by controlling a display panel including a plurality of modules according to an embodiment of the present disclosure;

FIG. 6 is a diagram for describing the display device for sequentially updating the plurality of modules according to an embodiment of the present disclosure;

FIG. 7 is a diagram for describing a color circle according to an embodiment of the present disclosure;

FIG. 8 is a diagram for describing a color corresponding to the partial region according to an embodiment of the present disclosure;

FIG. 9 is a diagram for describing the display device for arranging colors available on the display panel, from a first color to a second color, along the color circle according to an embodiment of the present disclosure; and

FIG. 10 is a flowchart for describing a control method of a display device according to an embodiment of the present disclosure.

### DETAILED DESCRIPTION

Hereinafter, embodiments of the present disclosure are described in detail with reference to the accompanying drawings.

The embodiments described in the disclosure, and the configurations shown in the drawings, are only examples, and various modifications may be made without departing from the scope and spirit of the disclosure.

General terms that are currently widely used are selected as terms used in embodiments of the present disclosure in consideration of their functions in the present disclosure, and may be changed based on the intention of those skilled in the art or a judicial precedent, the emergence of a new technique, or the like. In addition, in a specific case, terms arbitrarily chosen by an applicant may exist. In this case, the meanings of such terms are mentioned in detail in corresponding descriptions of the present disclosure. Therefore, the terms used in the present disclosure need to be defined on the basis of the meanings of the terms and the contents throughout the present disclosure rather than simple names of the terms.

In the present disclosure, an expression “have”, “may have”, “include”, “may include” or the like, indicates existence of a corresponding feature (for example, a numerical value, a function, an operation or a component such as a part), and does not exclude existence of an additional feature.

An expression, “at least one of A or B” may indicate “A,” “B,” or “both of A and B. ” Expressions “first”, “second” and the like, used in the present disclosure may indicate various components regardless of the sequence or importance of the components. The expression is used only to distinguish one component from another component, and does not limit the corresponding component.

If any component (for example, a first component) is mentioned to be “(operatively or communicatively) coupled with/to” or “connected to” another component (for example, a second component), it should be understood that the any component is directly coupled to another component or may be coupled to another component through yet another component (for example, a third component).

A term of a singular number may include its plural number unless explicitly indicated otherwise in the context. It should be understood that a term “include” or “have” used in this application specifies the presence of features, numerals, steps, operations, components, parts, or combinations thereof, which are mentioned in the specification, and does not preclude the presence or addition of one or more other features, numerals, steps, operations, components, parts, or combinations thereof.

In the specification, such a term as a “user” may refer to a person who uses a display device or a device (for example, an artificial intelligence electronic device) which uses the display device.

Hereinafter, embodiments of the present disclosure are described in detail with reference to the accompanying drawings.

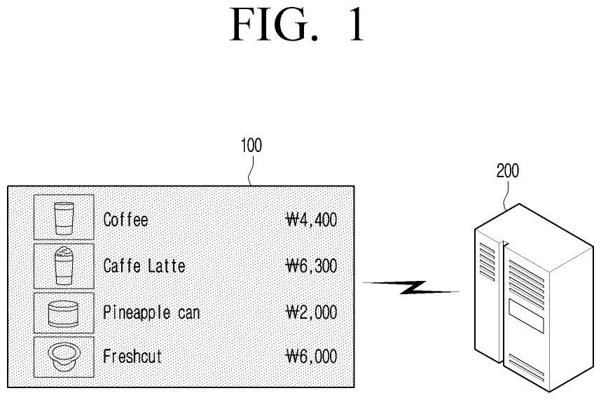

FIG. 1 is a diagram for describing a display device according to an embodiment of the present disclosure.

Referring to FIG. 1, a display device 100 may include at least one of a user terminal device, a tablet personal computer (PC), an electronic paper display (e-paper display) device, a mobile phone, a video phone, an electronic book reader, a desktop PC, a laptop PC, a netbook computer, a workstation, a server, a personal digital assistant (PDA), a portable multimedia player (PMP), an MP3 player, a medical device, a camera, a virtual reality (VR) implementation device, or a wearable device. Here, the wearable device may include at least one of an accessory-type wearable device (for example, a watch, a ring, a bracelet, an anklet, a necklace, glasses, contact lenses, or a head-mounted device (HMD)), a textile or clothing-integrated wearable device (for example, an electronic clothing), a body-attached wearable device (for example, a skin pad or a tattoo), or a biologically implantable circuit. In some embodiments, the display device 100 may include at least one of a television, a digital video disk (DVD) player, an audio system, a refrigerator, an air conditioner, a vacuum cleaner, an oven, a microwave oven, a washing machine, an air purifier, a source device (e.g., a set-top box, a cloud server, or an over-the-top media (OTT) service server), a home automation control panel, a security control panel, a media box (e.g., Samsung HomeSync™, AppleTV™, or Google TV™), a game console (e.g., Xbox™, PlayStation™, or Switch™), an electronic dictionary, an electronic key, a camcorder, or an electronic picture frame.

In another embodiment, the display device 100 may include at least one of various medical devices (e.g., various portable medical measuring devices (such as a blood glucose monitor, a heart rate monitor, a blood pressure monitor or a body temperature monitor), a magnetic resonance angiography (MRA), a magnetic resonance imaging (MRI), a computed tomography (CT), a camera (or a ultrasonicator), a navigation device, a global positioning system (for example, global navigation satellite system (GNSS)), an event data recorder (EDR), a flight data recorder (FDR), an automotive infotainment device, marine electronic equipment (e.g., a marine navigation system or a gyro compass), an avionics, a security device, a vehicle head unit, an industrial or home robot, a drone, an automated teller machine (ATM) in a financial institution, a point of sales (POS) in a store or an internet of things device (e.g., a light bulb, various sensors, a sprinkler device, a fire alarm, a thermostat, a street light, a toaster, fitness equipment, a hot water tank, a heater or a boiler).

For convenience of description, FIG. 1 assumes and shows the display device 100 as the electronic paper display device or an electrophoretic display device, and is not limited thereto.

According to an embodiment, the electrophoretic display device may include a display panel using electronic ink (e-ink) and having characteristics similar to those of paper printouts.

According to an embodiment, the electrophoretic display device may provide content by reflecting external light without a backlight. The electrophoretic display device does not emit light and provides content by using natural light, and thus may be operated using low power.

According to an embodiment, the electrophoretic display device may consume power only if a screen is refreshed based on a change in the content, and may continuously display the screen after the screen is refreshed without additional power consumption. Due to these advantages, the electrophoretic display device may be used for e-books, price tags, menu boards, or the like.

In an embodiment, the electrophoretic display device may include microcapsules, and each of the microcapsules may include a positively charged white particle and a negatively charged black particle.

According to an embodiment, the electrophoretic display device may determine a color of each pixel by using an electric field to move either the white particle or the black particle to a surface (or a front surface) of the electrophoretic display device. For example, the electrophoretic display device may apply a negative charge to the white particle to move the white particle to the front surface or apply a positive charge to the black particle to move the black particle to the front surface, thereby determining the color of each pixel and displaying the content (e.g., an image or text).

However, each of the microcapsules is not limited thereto, and may include various colored particles in addition to the white particle and the black particle. For example, each of the microcapsules may further include the various colored particles, such as a red particle, a green particle, and a blue particle, and may express colors included in the content by using various colored particles.

According to an embodiment, the display device 100 may communicate with a server 200 and receive and provide the content from the server 200.

According to an embodiment, if the content is received from the server 200, the display device 100 may consume power to refresh the screen to provide the content, and may provide the content without additional power consumption. In addition, if the changed content is received from the server 200 while the display device 100 provides the content, the display device 100 may consume power to refresh the screen to provide the changed content, and may provide the changed content without additional power consumption.

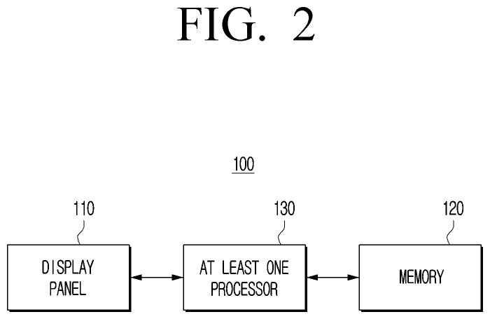

FIG. 2 is a block diagram of an exemplary display device capable of performing operations described according to an embodiment of the present disclosure.

Referring to FIG. 2, the display device 100 according to an embodiment may include a display panel 110, a memory 120, and at least one processor 130.

According to an embodiment, the display panel 110 may be implemented as any of various types of display panels such as a liquid crystal display (LCD), an organic light-emitting diode (OLED), a liquid crystal on silicon (LCoS), a digital light processing (DLP), a quantum dot (QD), a quantum dot light-emitting diode (QLED), a micro light-emitting diode (μLED), or a mini LED display. Meanwhile, the display panel 110 may be implemented as a touchscreen combined with a touch sensor, a flexible display, a rollable display, a three-dimensional (3D) display, a display in which the plurality of display modules are physically connected with each other, or the like.

According to an embodiment, the display panel 110 may be implemented as the electrophoretic display, and as described above, may be implemented as a display using electronic ink (e-ink) and having characteristics similar to those of paper printouts. According to an embodiment, the display panel 110 may provide a screen by reflecting external light without a separate backlight. For example, the display panel 110 does not emit light, and provides the screen by using natural light (or reflected light), and thus may be operated using low power.

For example, if the display panel 110 is implemented as the electrophoretic display (EPD), the display panel 110 may require power (e.g., electrical energy) only if the screen is switched (or refreshed).

According to an embodiment, the memory 120 may store data required for various embodiments of the present disclosure. According to an embodiment, the memory 120 may be implemented as a memory embedded in the display device 100 or as a memory detachably attached to the display device 100, based on a data storage purpose.

For example, data for operating the display device 100 may be stored in the memory embedded in the display device 100, and data for expanded functions of the display device 100 may be stored in the memory detachably attached to the display device 100. Meanwhile, the memory embedded in the display device 100 may be implemented as at least one of a volatile memory (e.g., a dynamic random access memory (DRAM), a static RAM (SRAM), or a synchronous dynamic RAM (SDRAM)) or a non-volatile memory (e.g., an one time programmable read only memory (OTPROM), a programmable ROM (PROM), an erasable and programmable ROM (EPROM), an electrically erasable and programmable ROM (EEPROM), a mask ROM, or a flash ROM), a flash memory (e.g., a NAND flash or a NOR flash), a hard drive, or a solid state drive (SSD)). In addition, the memory detachably attached to the display device 100 may be implemented as a memory card (e.g., a compact flash (CF), a secure digital (SD), a micro secure digital (Micro-SD), a mini secure digital (Mini-SD), an extreme digital (xD), or a multi-media card (MMC)), or an external memory which may be connected to a universal serial bus (USB) port (e.g., a USB memory).

According to an embodiment, the memory 120 may store at least one instruction for controlling the display device 100 or a computer program including this instruction.

According to an embodiment, at least one processor 130 may control overall operations of the display device 100. In detail, at least one processor 130 may be connected to each component of the display device 100 and control the overall operations of the display device 100.

According to an embodiment, at least one processor 130 may perform the operation of the electronic device 100 according to the various embodiments by executing at least one instruction stored in the memory 120.

According to an embodiment, at least one processor 130 may be implemented as a digital signal processor (DSP), a microprocessor, or a timing controller (TCON), each of which processes a digital signal. However, at least one processor 130 is not limited thereto, and may include at least one of a central processing unit (CPU), a micro controller unit (MCU), a micro processing unit (MPU), a controller, an application processor (AP), a communication processor (CP), an ARM processor, an artificial intelligence (AI) processor, or may be defined by a relevant term. In addition, at least one processor 130 may be implemented as a system-on-chip (SoC) or a large scale integration (LSI) that has a processing algorithm embedded therein, or may be implemented as a field programmable gate array (FPGA). At least one processor 130 may perform various functions by executing computer executable instructions stored in the memory.

At least one processor 130 may include one or more of a central processing unit (CPU), a graphic processing unit (GPU), an accelerated processing unit (APU), a many integrated core (MIC), a digital signal processor (DSP), a neural processing unit (NPU), a hardware accelerator, or a machine learning accelerator. At least one processor 130 may control one or any combination of other components included in the electronic device, and may perform operations related to communication or data processing. At least one processor 130 may execute at least one program or instruction stored in the memory. For example, at least one processor 130 may perform a method according to an embodiment of the present disclosure by executing at least one instruction stored in the memory.

If the method according to an embodiment of the present disclosure includes a plurality of operations, the plurality of operations may be performed by a single processor, or may be performed by a plurality of processors. For example, if a first operation, a second operation, and a third operation are performed by the method according to an embodiment, the first operation, the second operation, and the third operation may all be performed by a first processor. The first operation and the second operation may be performed by the first processor (for example, a general-purpose processor), and the third operation may be performed by a second processor (for example, an artificial intelligence-only processor).

At least one processor 130 may be implemented as a single-core processor including a single core, or may be implemented as at least one multi-core processor including multiple cores (for example, homogeneous multiple cores or heterogeneous multiple cores). If at least one processor 130 is implemented as the multi-core processor, each of the multiple cores included in the multi-core processor may include a processor internal memory such as a cache memory or an on-chip memory, and a common cache shared by the multiple cores may be included in the multi-core processor. In addition, each (or some) of the multiple cores included in the multi-core processor may independently read and perform a program instruction for implementing the method according to an embodiment of the present disclosure, or all (or some) of the multiple cores may be linked with each other to read and perform the program instruction for implementing the method according to an embodiment of the present disclosure.

If the method according to an embodiment of the present disclosure includes the plurality of operations, the plurality of operations may be performed by the single core among the multiple cores included in the multi-core processor, or may be performed by the multiple cores. For example, if the first operation, the second operation, and the third operation are performed using the method according to an embodiment, the first operation, the second operation, and the third operation may all be performed by a first core included in the multi-core processor. Alternatively, the first operation and the second operation may be performed by the first core included in the multi-core processor, and the third operation may be performed by a second core included in the multi-core processor.

In the embodiments of the present disclosure, the processor may indicate a system-on-chip (SoC) in which at least one processor and other electronic components are integrated with each other, the single-core processor, the multi-core processor, or the core included in the single-core processor or the multi-core processor. Here, the core may be implemented as the CPU, the GPU, the APU, the MIC, the DSP, the NPU, the hardware accelerator, the machine learning accelerator, or the like. However, the embodiments of the present disclosure are not limited thereto.

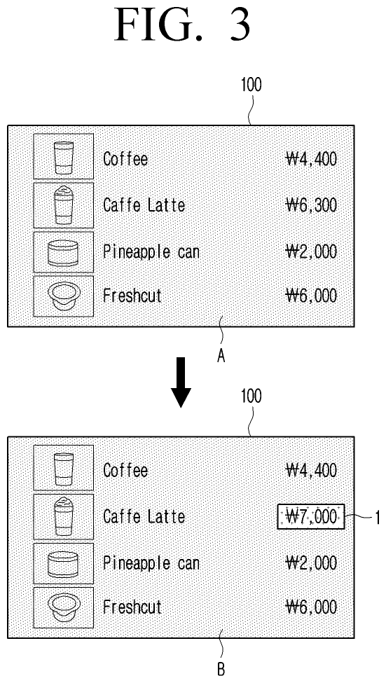

FIG. 3 is a diagram for describing the display device for displaying second content, in which a partial region in first content is changed, according to an embodiment of the present disclosure.

According to an embodiment of the present disclosure, the display device 100 may display first content A on the display panel 110. For example, the display device 100 may receive the first content A from the server 200 and display the first content A.

According to an embodiment, if the display device 100 is implemented as the electrophoretic display device, the display device 100 may consume power to refresh the display panel 110 (e.g., the electrophoretic display) to provide the first content A.

For example, the display device 100 may control the display panel 110 (e.g., the electrophoretic display) to provide a screen corresponding to the first content A by controlling each of the microcapsules using the electric field to move either the positively charged white particle or the negatively charged black particle included in each of the microcapsules.

According to an embodiment, the display device 100 may provide changed content (hereinafter, second content B).

For example, the second content B may include content in which a partial region 1 in the first content is changed.

According to an embodiment, the display device 100 may be implemented as an electrophoretic display device for primarily displaying content in which a frame change rarely occurs or occurs at a predetermined time interval (e.g., 24 hours), such as a price tag or a menu board, as opposed to content in which a frame change frequently occurs (e.g., 60 frames per second (fps)), such as a movie or a game.

According to an embodiment, between prior content (e.g., the first content A) provided by the display device 100 and new content (or changed content) (e.g., the second content B), an entire region may be changed, or only the partial region 1 may be changed. In particular, for content such as the menu board, only the partial region 1 may be changed between the prior content (e.g., the first content A) and the new content (e.g., the second content B), such as changing some menus included in the menu board to other menus, changing the prices of some menus, or overlapping a user interface (UI) indicating sold-out for some menus (the content may be only partially updated from the prior content).

According to an embodiment, if the display device 100 refreshes the display panel 110 by applying the electric field to all the microcapsules included in the display panel 110 to provide the second content in which only the partial region 1 in the first content is changed, flicker may occur in a remaining region excluding the partial region 1 due to the application of the electric field, and a considerable amount of time may be consumed to refresh all the microcapsules included in the display panel 110.

The display device 100 according to an embodiment of the present disclosure may refresh only the changed partial region 1 of the display panel 110, rather than the entire region, to provide the second content B in which the partial region 1 in the first content A is changed.

Referring to FIG. 3, the display device 100 may display the first content A, and display the second content B by refreshing the partial region 1 if the second content B, in which the partial region 1 in the first content A is changed, is obtained (or received) while the first content A is displayed.

According to an embodiment, the display device 100 may refresh only the changed partial region 1 between the prior content (e.g., the first content A) and the new content (e.g., the second content B), and maintain (or not refresh) the remaining region, thereby preventing unnecessary flicker in the remaining region. In addition, the display device 100 may refresh only the partial region 1 rather than the entire region of the display panel 110, thereby reducing waste of time and power.

According to an embodiment, the flicker occurring in the electrophoretic display device may be an inherent phenomenon occurring in a process in which the electrophoretic display device refreshes the display panel 110 to provide the content (e.g., the first content A or the second content B). For example, the flicker may occur in a process in which the display device 100 aligns the black particles and the white particles respectively included in the microcapsules to correspond to the new content to provide the new content (e.g., the second content B).

In addition, if the display device 100 provides the prior content (e.g., the first content A) for a long time, each of the black particles or the white particles included in the microcapsules may be fixed at a current position, thus causing a ghosting phenomenon. According to an embodiment, the display device 100 may align the black particles or the white particles respectively included in the microcapsules to their initial positions and then align the particles to correspond to the new content (e.g., the second content B) to prevent the occurrence of the ghosting phenomenon, and the flicker may occur while the black particles or the white particles are respectively aligned.

According to an embodiment, if the flicker occurs in the entire region of the display panel 110, a quality of user experience may deteriorate, and the unnecessary flicker may occur in the remaining region excluding the changed partial region 1 between the prior content (e.g., the first content A) and the new content (e.g., the second content B).

According to an embodiment of the present disclosure, the display device 100 may provide the new content, for example, the second content B by refreshing the changed partial region 1 between the first content A and the second content B. Accordingly, the flicker may occur only in the partial region 1 and may not occur in the remaining region.

For example, the display device 100 may receive coordinate information and the second content B. According to an embodiment, the display device 100 may identify the changed partial region 1 between the first content A and the second content B based on the coordinate information.

According to an embodiment, the display device 100 may identify the partial region 1 corresponding to the coordinate information in the first content A that is currently displayed by the display device 100, and display the second content B by refreshing the partial region 1 to correspond to the second content B.

According to an embodiment, if the display device 100 provides the second content B by refreshing only the partial region 1, a boundary line may occur between the newly refreshed partial region 1 and the remaining region that is not refreshed in the second content B provided by the display device 100.

For example, as shown in FIG. 3, even if a background color of the partial region 1 and a background color of the remaining region are the same in the second content B provided by the display device 100, the particles included in the microcapsules corresponding to the partial region 1 (e.g., the black and white particles) and the particles included in the microcapsules corresponding to the remaining region (e.g., the black and white particles) may not be aligned simultaneously, which may cause a slight difference in arrangement states (or alignment states) between the particles (e.g., inconsistency in the arrangement states between the particles), and these slight difference may generate the boundary line. In addition, the ghosting phenomenon may occur in the remaining region, a slight color difference may thus occur between the newly refreshed partial region 1 and the non-refreshed remaining region (or a contrast may occur between the partial region 1 and the remaining region), and the color difference may cause the boundary line.

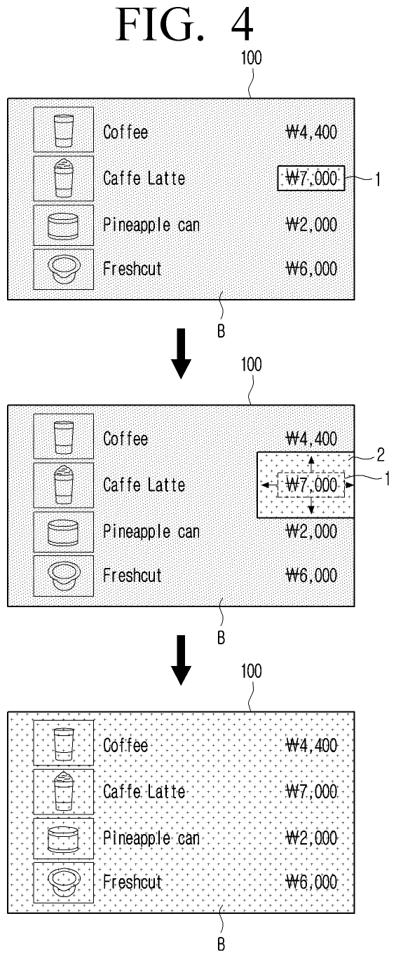

FIG. 4 is a diagram for describing the display device for sequentially refreshing pixels adjacent to the partial region according to an embodiment of the present disclosure.

Referring to FIG. 4, the display device 100 according to an embodiment of the present disclosure may provide the second content B by refreshing the partial region 1 corresponding to the first content A, and may refresh a remaining region 2 excluding the partial region 1 to remove the boundary line that occurs between the partial region 1 and the remaining region 2 in the second content B.

According to an embodiment, the display device 100 may provide the second content B by refreshing only the changed partial region 1 in the first content A instead of refreshing the entire region of the display panel 110, and may then refresh the remaining region 2 to remove the boundary line that occurs between the partial region 1 and the remaining region 2 (or the contrast between the partial region 1 and the remaining region 2).

According to an embodiment, the display device 100 may simultaneously refresh a plurality of pixels corresponding to the remaining region 2, or may sequentially refresh the plurality of pixels corresponding to the remaining region 2.

For example, the display device 100 may identify the partial region 1 based on the coordinate information, and sequentially refresh the pixels adjacent to the partial region 1 among the plurality of pixels included in the remaining region 2.

For example, the display device 100 may provide the second content B by refreshing pixels corresponding to the partial region 1 among the plurality of pixels included in the display panel 110. Next, the display device 100 may preferentially refresh the pixels adjacent to the partial region 1 in at least one of upper, lower, left, and right directions among the pixels corresponding to the remaining region 2.

According to an embodiment, as shown in FIG. 4, the display device 100 may refresh the plurality of pixels corresponding to the remaining region 2 by sequentially refreshing the pixels corresponding to the remaining region 2 in upper, lower, left, and right directions, at a predetermined time interval, starting with the pixels closest to the partial region 1 and ending with pixels farthest from the partial region 1 (e.g., pixels disposed at an edge of the display panel 110), in at least one of the upper, lower, left, and right directions, at the predetermined time interval (e.g., five seconds). According to an embodiment, the predetermined time interval may be variously changed based on a user setting, a setting via the server 200 that provides the content (e.g., the first content or the second content), a setting based on firmware distributed by a manufacturer of the display device 100, or the like.

According to an embodiment, instead of refreshing only the partial region 1 and not refreshing the remaining region 2, the display device 100 may refresh the partial region 1 and then display the second content B by refreshing the remaining region 2, thereby preventing the problem in which the flicker occurring in the entire region deteriorates the quality of user experience or a long time is required to provide the second content B (see FIG. 3).

According to an embodiment, the display device 100 may refresh the remaining region 2 following the refreshing of the partial region 1 to remove the boundary line (or the contrast) that occurs between the partial region 1 and the remaining region 2 (see FIG. 4). For example, the display device 100 may simultaneously refresh the plurality of pixels included in the remaining region 2, or may refresh the plurality of pixels included in the remaining region 2 by sequentially refreshing the pixels adjacent to the partial region 1 to the pixels farther from the partial region 1.

According to an embodiment, if the display device 100 refreshes each of the plurality of microcapsules included in the display panel 110 and realigns positions of color particles included in each of the plurality of microcapsules, the display device 100 may prevent the occurrence of ghosting phenomenon and remove the boundary line while the new content (e.g., the second content B) is displayed.

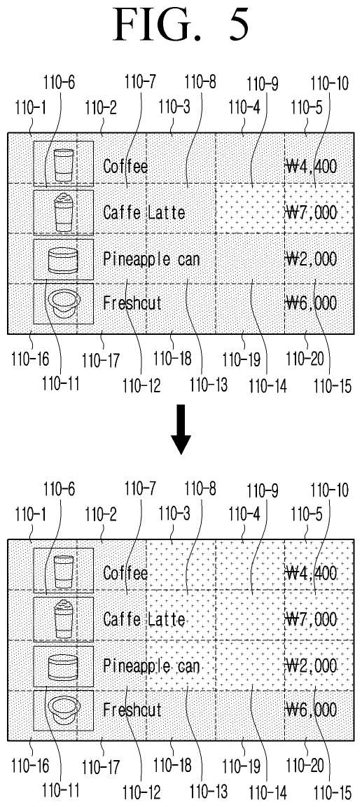

FIG. 5 is a diagram for describing the display device for displaying the second content by controlling the display panel including a plurality of modules according to an embodiment of the present disclosure.

According to an embodiment, the display panel 110 may include a plurality of modules 110-1 to 110-20.

For the convenience of description, FIG. 5 assumes that the display panel 110 includes the first to twentieth modules 110-1 to 110-20, and is not limited thereto.

According to an embodiment, the display device 100 may receive (or obtain) the coordinate information and the second content, and may identify the partial region that is changed between the first content A and the second content B based on the coordinate information.

According to an embodiment, the display device 100 may identify at least one module including the partial region among the plurality of modules 110-1 to 110-20.

According to an embodiment, the display device 100 may display the second content B by refreshing a first plurality of pixels included in at least one module including the partial region.

According to an embodiment, the display device 100 may display the second content B by refreshing the first plurality of pixels included in at least one module, and then refresh a second plurality of pixels included in each of the remaining modules excluding at least one module among the plurality of modules 110-1 to 110-20.

Referring to FIG. 5, the display device 100 may identify the ninth module 110-9 and the tenth module 110-10, which include the partial region changed between the first content A and the second content B among the plurality of modules 110-1 to 110-20.

According to an embodiment, the display device 100 may change the partial region in the first content A to correspond to the second content B by refreshing pixels included in the ninth module 110-9 and pixels included in the tenth module 110-10.

According to an embodiment, as shown in FIG. 5, a slight difference may occur in an arrangement state (or an alignment state) between the particles of the microcapsules included in the ninth module 110-9 and the tenth module 110-10 (e.g., the black and white particles) and the particles of the microcapsules included in a remaining module (e.g., the black and white particles) (e.g., inconsistency in the arrangement state between the particles), and the slight difference may cause the boundary line.

According to an embodiment, the display device 100 may refresh the pixels included in the ninth module 110-9 and the pixels included in the tenth module 110-10, and then refresh the pixels included in each of the remaining modules (e.g., the first module 110-1 to the eighth module 110-8 and the eleventh module 110-11 to the twentieth module 110-20).

According to an embodiment, the display device 100 may simultaneously refresh the remaining modules (e.g., the first module 110-1 to the eighth module 110-8 and the eleventh module 110-11 to the twentieth module 110-20) or may sequentially refresh the remaining modules.

For example, as shown in FIG. 5, the display device 100 may refresh the ninth module 110-9 and the tenth module 110-10, and then refresh the pixels included in each of the third module 110-3 to the fifth module 110-5, the eighth module 110-8, and the thirteenth module 110-13 to the fifteenth module 110-15 adjacent to the ninth module 110-9 and the tenth module 110-10 in the upper, lower, left, right, and diagonal directions.

For example, the display device 100 may refresh the ninth module 110-9 and the tenth module 110-10, and then after a predetermined time period (e.g., five seconds) elapses, refresh the pixels included in each of the third module 110-3 to the fifth module 110-5, the eighth module 110-8, and the thirteenth module 110-13 to the fifteenth module 110-15. According to an embodiment, the predetermined time interval may be changed in various ways based on the user setting, the setting via the server 200 that provides the content (e.g., the first content or the second content), the setting based on the firmware distributed by the manufacturer of the display device 100, or the like.

According to an embodiment, the display device 100 may refresh the third module 110-3 to the fifth module 110-5, the eighth module 110-8, and the thirteenth module 110-13 to the fifteenth module 110-15 to remove the boundary line between the ninth module 110-9 and the tenth module 110-10, which include the partial region, the third module 110-3 to the fifth module 110-5, the eighth module 110-8, or the thirteenth module 110-13 to the fifteenth module 110-15 adjacent to the ninth module 110-9 and the tenth module 110-10.

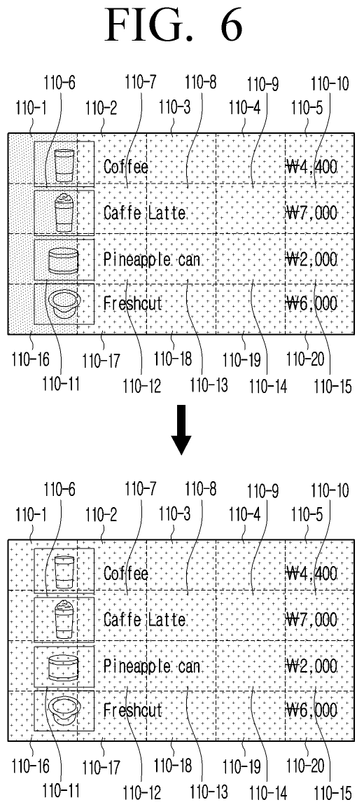

FIG. 6 is a diagram for describing the display device for sequentially updating the plurality of modules according to an embodiment of the present disclosure.

Referring to FIGS. 5 and 6, the display device 100 may sequentially update the remaining modules (e.g., the first module 110-1 to the eighth module 110-8 and the eleventh module 110-11 to the twentieth module 110-20) at the predetermined time interval.

For example, the display device 100 may refresh the third module 110-3 to the fifth module 110-5, the eighth module 110-8, and the thirteenth module 110-13 to the fifteenth module 110-15, adjacent to the ninth module 110-9 and the tenth module 110-10, which include the partial region, in the upper, lower, left, right, and diagonal directions. After the predetermined time period elapses (e.g., five seconds) elapses, the display device 100 may then refresh the second module 110-2, the seventh module 110-7, the twelfth module 110-12, and the seventeenth module 110-17 to the twentieth module 110-20, adjacent to the third module 110-3 to the fifth module 110-5, the eighth module 110-8, and the thirteenth module 110-13 to the fifteenth module 110-15, in the upper, lower, left, right, and diagonal directions.

After the predetermined time period (e.g., five seconds) elapses, the display device 100 may then refresh the first module 110-1, the sixth module 110-6, the eleventh module 110-11, and the sixteenth module 110-16, adjacent to the second module 110-2, the seventh module 110-7, the twelfth module 110-12, and the seventeenth module 110-17 to the twentieth module 110-20 in the upper, lower, left, right, and diagonal directions.

According to an embodiment, the display device 100 may sequentially refresh the remaining modules (e.g., the first module 110-1 to the eighth module 110-8 and the eleventh module 110-11 to the twentieth module 110-20) at the predetermined time interval, thereby refreshing the plurality of modules 110-1 to 110-20 included in the display panel 110 and preventing the occurrence of the boundary line on the screen (or removing the boundary line) while the second content B is displayed.

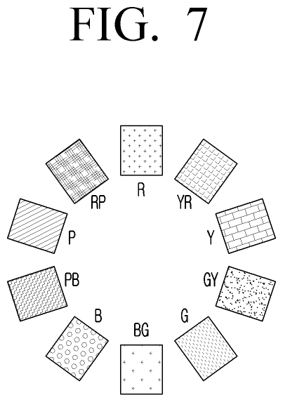

FIG. 7 is a diagram for describing a color circle according to an embodiment of the present disclosure.

FIG. 7 shows an example of the color circle, in which colors are arranged in a ring shape to represent a change in colors.

Referring to a ten-color circle shown in FIG. 7, ten colors are arranged in the ring shape to represent the change in the ten colors, and a mixing relationship and a contrast (or complementary color) relationship between the colors are represented.

For example, the ten-color circle includes red, yellow, green, blue, and purple, and may also include yellow-red, which is a mixture of red and yellow and disposed between red and yellow, green-yellow, which is a mixture of yellow and green and disposed between yellow and green, blue-green, which is a mixture of green and blue and disposed between green and blue, purple-blue, which is a mixture of blue and purple and disposed between blue and purple, and red-purple, which is a mixture of purple and red and disposed between purple and red. For example, red and cyan, which are opposite to each other in the ten-color circle, may be contrasting (or complementary) colors.

According to an embodiment, each of the plurality of microcapsules included in the display device 100 may include various colored particles, such as a green particle, a blue particle, a yellow particle, and a red particle, in addition to the black particle and the white particle. For the convenience of description, each of the plurality of microcapsules included in the display panel 110 are assumed and described as including the black particle, the white particle, the green particle, the blue particle, the yellow particle, and the red particle.

According to an embodiment, the display device 100 may express a color included in the content (e.g., the first content A or the second content B) by combining (or mixing) the various color particles.

For example, the display device 100 may sequentially align (or move) the plurality of color particles based on a predetermined order, respectively. For example, the display device 100 may display the content by sequentially aligning the plurality of color particles in an order of the black particle, the white particle, the green particle, the blue particle, the yellow particle, and the red particle. For example, the display device 100 may change the partial region in the prior content (e.g., the first content A) by sequentially aligning the plurality of color particles included in the microcapsules corresponding to the partial region based on the predetermined order, and change (or refresh) the partial region to correspond to the new content (e.g., the second content B).

For example, if the display device 100 sequentially aligns the plurality of color particles in the predetermined order, the display device 100 may align a third color particle (e.g., the yellow particle) having a close contrast (or complementary) color relationship with the first color particle, rather than aligning a second color particle (e.g., the red particle) adjacent to a first color particle along the color circle after aligning the first color particle (e.g., the blue particle).

According to an embodiment, if the display device 100 aligns the third color particle having the close contrast relationship with the first color particle after aligning the first color particle, the quality of user experience may deteriorate due to a sudden color change, and an illusion may be created that the display panel 110 is broken.

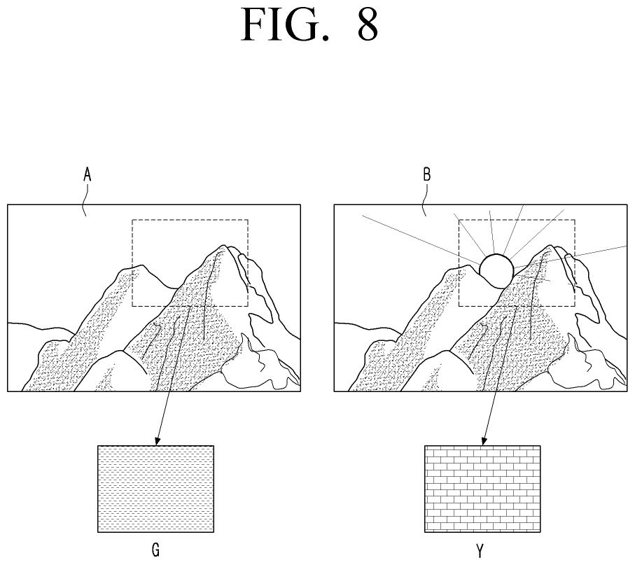

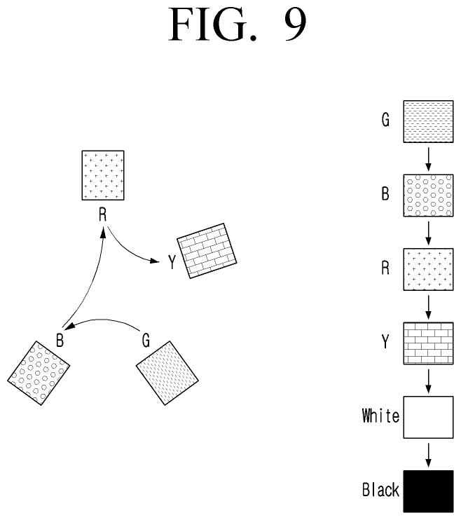

According to an embodiment, the display device 100 may sequentially align the plurality of color particles based on the predetermined order, or may control the display panel 110 to align the second color particle adjacent to the first color particle after aligning the first color particles along the color circle. A detailed description thereof is provided with reference to FIGS. 8 and 9.

FIG. 8 is a diagram for describing a color corresponding to the partial region according to an embodiment of the present disclosure.

According to an embodiment, if the coordinate information and the second content B are received, the display device 100 may identify the partial region in the first content A based on the coordinate information.

According to an embodiment, the display device 100 may identify the first color (e.g., green) corresponding to the partial region in the first content A among the plurality of color particles included in the display panel 110.

For example, the display device 100 may identify a representative color (or an average color) of the partial region in the first content A as the first color based on average color coordinates of the pixels included in the partial region in the first content A.

According to an embodiment, the display device 100 may identify the second color (e.g., yellow) corresponding to the changed partial region in the second content B.

For example, the display device 100 may identify the representative color (or the average color) of the changed partial region in the second content B as the second color based on the average color coordinates of pixels included in the changed partial region in the second content B.

According to an embodiment, the display device 100 may arrange colors available on the display panel 110, from the first color to the second color, along the color circle. A detailed description thereof is provided with reference to FIG. 9.

FIG. 9 is a diagram for describing the display device for arranging the colors available on the display panel, from the first color to the second color, along the color circle according to an embodiment of the present disclosure.

Referring to FIG. 8, the display device 100 may identify the partial region in the first content A as corresponding to the first color, and identify the changed partial region in the second content B as corresponding to the second color.

According to an embodiment, the display device 100 may arrange the first color to the fourth color along the color circle if the first color and the second color are adjacent to each other, and then arrange the black particle and the white particle last.

For example, the display device 100 may identify the partial region in the first content A as corresponding to the color green, and the changed partial region in the second content B as corresponding to the color yellow.

As shown in FIG. 9, green and yellow are adjacent to each other. Accordingly, the display device 100 may arrange the remaining colors, from green to yellow, excluding black and white, among the colors available on the display panel 110, for example, green, blue, red and yellow.

For example, the display device 100 may arrange green along the color circle, then arrange blue adjacent to green, then arrange red adjacent to blue, and then arrange yellow. Next, the display device 100 may arrange white and black (or black and white) last.

According to an embodiment, the display device 100 may sequentially align (or arrange) the plurality of color particles in an order of the green particle, the blue particle, the red particle, the yellow particle, the white particle, and then the black particle (or, the black particle followed by the white particle) in a process for refreshing the partial region in the first content A to correspond to the second content B.

However, this configuration is an example provided for the convenience of explanation and the present disclosure is not limited thereto.

According to an embodiment, if the first color and the second color are not adjacent to each other, the display device 100 may fix the first color first, fix the second color last, and then arrange the black particle, the white particle, the third color, and the fourth color between the first color and the second color along the color circle.

For example, the display device 100 may identify the partial region in the first content A as corresponding to green, and the changed partial region in the second content B as corresponding to red.

As shown in FIG. 9, green and red are not adjacent to each other. Accordingly, the display device 100 may arrange the colors available on the display panel 110, from green to red.

For example, the display device 100 may arrange green along the color circle, and then arrange blue adjacent to green. Next, the display device 100 may exclude red, which is adjacent to blue, from the plurality of color particles because red needs to be arranged last, exclude yellow because yellow has a close contrast (or complementary) relationship with blue, and arrange white and black (or black and white). The display device 100 may then arrange yellow, and arrange red last.

According to an embodiment, the display device 100 may sequentially align (or arrange) the plurality of color particles in an order of the green particle, the blue particle, the white particle, the black particle (or the black particle followed by the white particle), the yellow particle, and then the red particle in the process for refreshing the partial region in the first content A to correspond to the second content B.

According to an embodiment, the display device 100 may improve the quality of user experience by minimizing the occurrence of sudden color changes in the process for refreshing the display panel 110 to change the partial region, and may avoid causing the illusion that the display panel 110 is broken.

Referring back to FIG. 2, the display device 100 may further include a communication interface.

The communication interface may input and output various types of data. For example, the communication interface may transmit and receive the various types of data to and from an external device (e.g., a source device), an external storage medium (e.g., a universal serial bus (USB) memory), an external server (e.g., a web hard) by using a communication method such as access point (AP)-based wireless fidelity (Wi-Fi, wireless local area network (LAN)), Bluetooth, Zigbee, wired/wireless local area network (LAN), wide area network (WAN), Ethernet, IEEE 1394, high definition multimedia interface (HDMI), universal serial bus (USB), mobile high-definition link (MHL), audio engineering society/European broadcasting union (AES/EBU) communication, optical communication, or coaxial communication.

In an example, the communication interface may include a Bluetooth low energy (BLE) module. The BLE refers to a Bluetooth technology that enables transmission and reception of low-power and low-capacity data in a 2.4 gigahertz (GHz) frequency band having a range of about 10 m. However, the present disclosure is not limited thereto, and the communication interface may include a Wi-Fi communication module. For example, the communication interface may include at least one of the Bluetooth low energy (BLE) module or the Wi-Fi communication module.

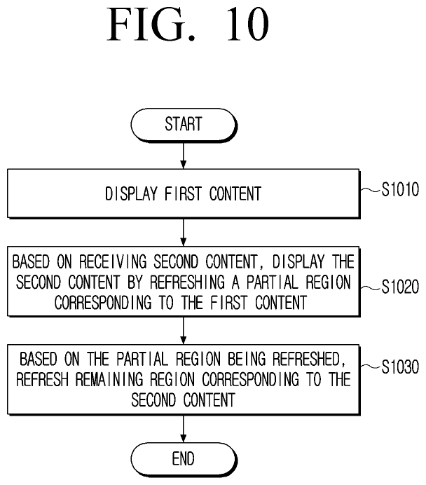

FIG. 10 is a flowchart for describing a control method of a display device according to an embodiment of the present disclosure.

Referring to FIG. 10, the operation method of a display device including the display panel may include displaying the first content (S1010).

According to an embodiment, the operation method may include displaying the second content by refreshing the partial region in the first content if the second content, in which the partial region in the first content is changed, is received (S1020).

According to an embodiment, the operation method may include refreshing the partial region and then refreshing the remaining region in the second content, excluding the partial region (S1030).

According to an embodiment, the displaying of the second content (S1020) may include identifying the partial region in the first content based on the coordinate information if the coordinate information and the second content are received, and displaying the second content by refreshing the partial region in the first content to allow the partial region to correspond to the second content.

According to an embodiment, the operation method may further include refreshing the plurality of pixels included in the remaining region by sequentially refreshing the pixels adjacent to the partial region among the plurality of pixels included in the remaining region based on the coordinate information corresponding to the partial region.

According to an embodiment, the refreshing of the plurality of pixels may include refreshing the plurality of pixels included in the remaining region by sequentially refreshing the plurality of pixels, from the pixels closest to the partial region to the farthest pixels among the plurality of pixels, in the upper, lower, left, and right directions, at the predetermined time interval.

According to an embodiment, the display panel may include the plurality of modules.

According to an embodiment, the displaying of the second content (S1020) may include identifying at least one module including the partial region among the plurality of modules and displaying the second content by refreshing the identified pixels included in at least one module.

According to an embodiment, the refreshing of the remaining region (S1030) may include refreshing the identified pixels included in at least one module and then refreshing pixels included in each of the remaining modules excluding the identified at least one module among the plurality of modules.

According to an embodiment, the display panel may be implemented as the electrophoretic display.

According to an embodiment, the displaying of the second content (S1020) may include refreshing the partial region by adjusting the positions of the color particles of each pixel included in the partial region.

According to an embodiment, the refreshing of the remaining region (S1030) may include refreshing the partial region and then refreshing the remaining region by adjusting the positions of the color particles of the pixels of the remaining region.

According to an embodiment, the operation method may further include identifying the first color corresponding to the first content being displayed in the partial region from among the color particles of the display panel, identifying the second color corresponding to the second content to be displayed in the partial region, from among the color particles included in the display panel, arranging the color particles, from the first color to the second color, based on the color circle including the first color and the second color, and sequentially adjusting the color particles included in the display panel based on the arrangement. The plurality of color particles may be sequentially adjusted based on the arrangement if the first color and the second color match.

According to an embodiment, the displaying of the second content (S1020) may include refreshing the partial region by adjusting the color particles of each of the pixels included in the partial region based on the arrangement.

According to an embodiment, the refreshing of the remaining region (S1030) may include refreshing the partial region and then refreshing the remaining region by adjusting the color particles of each of the pixels included in the remaining region based on the arrangement.

The methods according to the various embodiments of the present disclosure described above may be implemented in the form of an application capable of being installed on a conventional display device. The methods according to the various embodiments of the present disclosure described above may be performed using a deep learning-based trained neural network (or deep trained neural network), for example, the learning network model. In addition, the methods according to the various embodiments of the present disclosure described above may be implemented only by software upgrade or hardware upgrade of the conventional display device. In addition, the various embodiments of the present disclosure described above may be performed through an embedded server included in the display device, or an external server of the display device.

Meanwhile, according to an embodiment of the present disclosure, the various embodiments described above may be implemented in software including an instruction stored on a machine-readable storage medium (for example, a computer-readable storage medium). A machine may be a device that invokes the stored instruction from a storage medium, may be operated based on the invoked instruction, and may include the display device (e.g., display device A) according to the disclosed embodiments. If the instruction is executed by the processor, the processor may directly perform a function corresponding to the instruction or other components may perform the function corresponding to the instruction under control of the processor. The instruction may include codes provided or executed by a compiler or an interpreter. The machine-readable storage medium may be provided in the form of a non-transitory storage medium. Here, the term “non-transitory” indicates that the storage medium is tangible without including a signal, and does not distinguish whether data are semi-permanently or temporarily stored on the storage medium.

In addition, according to an embodiment, the methods according to the various embodiments described above may be included and provided in a computer program product. The computer program product may be traded as a commodity between a seller and a purchaser. The computer program product may be distributed in a form of the machine-readable storage medium (for example, a compact disc read only memory (CD-ROM)), or may be distributed online through an application store (for example, PlayStore™. In case of the online distribution, at least a part of the computer program product may be at least temporarily stored or temporarily provided on a storage medium such as the memory of a manufacturer server, an application store server, or a relay server.

In addition, each of the components (for example, modules or programs) according to the various embodiments described above may include a single entity or a plurality of entities, and some of the corresponding sub-components described above may be omitted or other sub-components may be further included in the various embodiments. Alternatively or additionally, some of the components (for example, the modules or the programs) may be integrated into the single entity, and may perform functions performed by the respective corresponding components before being integrated in the same or similar manner. Operations performed by the modules, the programs, or other components according to the various embodiments may be executed in a sequential manner, a parallel manner, an iterative manner, or a heuristic manner, at least some of the operations may be performed in a different order or be omitted, or other operations may be added.

Although the embodiments are shown and described in the present disclosure as above, the present disclosure is not limited to the above-described specific embodiments, and may be variously modified by those skilled in the art to which the present disclosure pertains without departing from the gist of the present disclosure as claimed in the accompanying claims. These modifications should also be understood to fall within the scope and spirit of the present disclosure.

What is claimed is:

1. A display device comprising:
a display panel;
at least one processor; and
memory storing instructions,
wherein the instructions, when executed by the at least one processor individually or collectively, cause the display device to:
display first content on the display panel,
based on receiving second content, display the second content on the display panel by refreshing a partial region of the display panel corresponding to the first content, and
based on the partial region being refreshed, refresh a remaining region of the display panel corresponding to the second content, excluding the partial region.

2. The display device as claimed in claim 1, wherein the instructions, when executed by the at least one processor individually or collectively, cause the display device to:
based on receiving coordinate information and the second content, identify the partial region based on the coordinate information, and
display the second content on the display panel by refreshing the partial region.

3. The display device as claimed in claim 2, wherein the instructions, when executed by the at least one processor individually or collectively, cause the display device to sequentially refresh a plurality of pixels corresponding to the remaining region that are adjacent to the partial region, based on the coordinate information.

4. The display device as claimed in claim 3, wherein the instructions, when executed by the at least one processor individually or collectively, cause the display device to refresh the plurality of pixels by sequentially refreshing the plurality of pixels in upper, lower, left, and right directions, at a predetermined time interval, starting with pixels closest to the partial region, and ending with pixels farthest from the partial region that are disposed along edges of the display panel.

5. The display device as claimed in claim 1, wherein the display panel comprises a plurality of modules, and
wherein the instructions, when executed by the at least one processor individually or collectively, cause the display device to:
identify at least one module that comprises the partial region from among the plurality of modules,
display the second content on the at least one module by refreshing a first plurality of pixels of the at least one module, and
based on the first plurality of pixels being refreshed, refresh a second plurality of pixels of one or more remaining modules, from among the plurality of modules, excluding the at least one module.

6. The display device as claimed in claim 1, wherein the display panel is an electrophoretic display.

7. The display device as claimed in claim 6, wherein the instructions, when executed by the at least one processor individually or collectively, cause the display device to:
refresh the partial region by adjusting positions of a plurality of color particles corresponding to the partial region, and
based on the partial region being refreshed, refresh the remaining region by adjusting positions of a plurality of particles of the remaining region.

8. The display device as claimed in claim 1, wherein the instructions, when executed by the at least one processor individually or collectively, cause the display device to:
identify a first color corresponding to the first content being displayed in the partial region from among a plurality of color particles of the display panel;
identify a second color corresponding to the second content to be displayed in the partial region, from among the plurality of color particles;
arrange the plurality of color particles of the display panel, from the first color to the second color, based on a color circle comprising the first color and the second color; and
sequentially adjust the plurality of color particles based on the arrangement of the plurality of color particles.

9. The display device as claimed in claim 8, wherein the instructions, when executed by the at least one processor individually or collectively, cause the display device to, the first color and the second color matching, sequentially adjust the plurality of color particles based on a predetermined arrangement.

10. The display device as claimed in claim 8, wherein the instructions, when executed by the at least one processor, individually or collectively, cause the display device to:
refresh the partial region by adjusting a plurality of color particles corresponding to a plurality of pixels included in the partial region based on the arrangement; and
based on the partial region being refreshed, refresh the remaining region by adjusting a plurality of color particles of corresponding to a plurality of pixels included in the remaining region based on the arrangement.

11. An operation method of a display device including a display panel, the operation method comprising:
displaying first content on the display panel;
based on receiving second content, displaying the second content on the display panel by refreshing a partial region of the display panel corresponding to the first content; and
based on the partial region being refreshed, refreshing a remaining region of the display panel corresponding to the second content, excluding the partial region.

12. The operation method as claimed in claim 11, wherein the displaying the second content comprises:
based on receiving coordinate information and the second content, identifying the partial region based on the coordinate information; and
displaying the second content on the display panel by refreshing the partial region.

13. The operation method as claimed in claim 12, further comprising sequentially refreshing a plurality of pixels corresponding to the remaining region that are adjacent to the partial region, based on the coordinate information.

14. The operation method as claimed in claim 13, wherein the sequentially refreshing the plurality of pixels comprises:
sequentially refreshing the plurality of pixels in upper, lower, left, and right directions, at a predetermined time interval, starting with pixels closest to the partial region, and ending with pixels farthest from the partial region that are disposed along edges of the display panel.

15. The operation method as claimed in claim 11, wherein the display panel comprises a plurality of modules,
wherein the displaying the second content comprises:
identifying at least one module that includes the partial region from among the plurality of modules; and
displaying the second content on the at least one module by refreshing a first plurality of pixels of the at least one module, and
wherein the refreshing the remaining region comprises:
based on the first plurality of pixels being refreshed, refreshing a second plurality of pixels included in one or more remaining modules, from among the plurality of modules, excluding the at least one module.

16. The operation method as claimed in claim 11, wherein the display panel is an electrophoretic display.

17. The operation method as claimed in claim 16, wherein the displaying the second content comprises refreshing the partial region by adjusting positions of a plurality of color particles corresponding to the partial region, and
wherein the refreshing the remaining region comprises, based on the partial region being refreshed, refreshing the remaining region by adjusting positions of a plurality of particles of the remaining region.

18. The operation method as claimed in claim 11, wherein the displaying the second content comprises:
identifying a first color corresponding to the first content being displayed in the partial region from among a plurality of color particles of the display panel;
identifying a second color corresponding to the second content to be displayed in the partial region, from among the plurality of color particles;
arranging the plurality of color particles of the display panel, from the first color to the second color, based on a color circle comprising the first color and the second color; and
sequentially adjusting the plurality of color particles based on the arrangement of the plurality of color particles.

19. The operation method as claimed in claim 18, wherein the sequentially adjusting the plurality of color particles comprises, based on the first color and the second color matching, sequentially adjusting the plurality of color particles based on a predetermined arrangement.

20. A non-transitory computer-readable recording medium having at least one instruction recorded thereon, that, when executed by at least one processor, individually or collectively, cause the at least one processor to:
display first content on a display panel;
based on receiving second content, display the second content on the display panel by refreshing a partial region of the display panel corresponding to the first content; and
based on the partial region being refreshed, refresh a remaining region of the display panel corresponding to the second content, excluding the partial region.
